(19) United States
(12) Patent Application Publication
(10) Pub. No.: US 2015/0137015 A1
(43) Pub. Date: May 21, 2015

(54) CONNECTOR FOR MICROFLUIDIC DEVICE, A METHOD FOR INJECTING FLUID INTO MICROFLUIDIC DEVICE USING THE CONNECTOR AND A METHOD OF PROVIDING AND OPERATING A VALVE

(71) Applicants: Guek Geok Alicia Toh, Singapore (SG); Zhenfeng Wang, Singapore (SG)

(72) Inventors: Guek Geok Alicia Toh, Singapore (SG); Zhenfeng Wang, Singapore (SG)

(73) Assignee: Agency for Science, Technology and Research, Singapore (SG)

(21) Appl. No.: 14/397,144

(22) PCT Filed: Jul. 12, 2012
(86) PCT No.: PCT/SG2012/000246

§ 371 Date: Jan. 21, 2015

(51) Int. Cl. F16K 99/00; F16L 37/04

(52) U.S. Cl. CPC F16K 99/0011; F16L 37/04; F16K 2099/0084
USPC 251/149

(57) ABSTRACT

A connector for being inserted into a first channel of a microfluidic device. The connector includes a first end and a second end, when seen in the direction of a longitudinal central axis of said connector, wherein the second end is arranged in a second end portion of the connector; an inner hollow space; a outer circumferential wall extending around said longitudinal central axis, such that said outer circumferential wall extends around said inner hollow space. The outer circumferential wall has at least two different outer diameters along said longitudinal central axis, which outer diameters differ in their value; and the outer surface of said circumferential wall is rotationally symmetrical with regard to said longitudinal central axis; an opening provided in said first end for receiving an insert and, being in fluid connection with said inner hollow space; and a membrane sealingly covering said inner hollow space towards said second end of the connector, wherein the insert is configured to provide pressure on said membrane.

### FIELD OF INVENTION

The present invention relates to a connector for microfluidic device, a method for injecting fluid into a microfluidic device and a method of providing and operating a valve for blocking and/or unblocking a fluid flow through a channel in the microfluidic device.

### BACKGROUND

In recent years, there is an evolving trend to conduct analysis on chemical compound using micro total analysis system (μTAs). μTAs integrates laboratory processes into one or more chips to perform the analysis and microfluidic devices are generally utilized to create a μTAS. As such, μTAS is also commonly known as lab-on a chip. With the miniaturization, the time taken and resources used to conduct the analysis are greatly reduced.

A microfluidic system may consist of one or more microfluidic devices and each device may have one or more functions, e.g. microvalves and micropumps. The microfluidic devices may be linked together to form a microfluidic system to perform, for example, an analysis of a chemical compound. To link up microfluidic components, interconnection between microfluidic device components is required. Typically, the microfluidic devices have ports on the devices to receive capillaries for transfer of fluid from one microfluidic device to another. The ports may also be used to receive fluid transfer from external source. As such, the ports are also known as macro-to-micro interface or world-to-chip interface. Generally, microfluidic devices consist of a substrate and channels are formed within the substrates for the purpose of channeling fluid injected into the devices. The channels are connected to the ports for channeling of fluid.

Many have researched into this area to come up with various designs for connectors. For example, a flanged tube has been used to connect capillaries where the flange of the tube is rigidly mounted in a substrate of the microfluidic system to connect the one end of the flanged tube to the channel in the substrate. The other free end is connected to a hollow insert for receiving fluid.

In another example, thermoplastic tubings are used to seal the interface between the hollow insert and substrate. To ensure the seal to be effective, the thermoplastic tubings are heated and deformed under applied pressure to conform into a shape, e.g. flanged shape, in the substrate. A metal insert in used to maintain a hole for the insertion of the hollow insert. Only when the thermoplastic tubing is cured then can a hollow insert be inserted to pump fluid into the substrate. Although this interface allows a more reliable connection, it may be troublesome and time consuming to manufacture. The cost to manufacture such an interface may also be relatively high.

In addition to connectors, microfluidic valves are also one of the key components of microfluidic devices. The valves are used to block or allow fluid flow in a channel. In one example, a channel in a microfluidic device has an upper wall or ceiling and a lower wall or floor made of electrodes. To actuate the valve, a voltage is driven through the electrodes and the attraction between the electrodes forces one or both walls to pull the electrodes together, hence blocking fluid flow through the channel. The common problem faced by the two types of microfluidic valves is the complexity in fabrication of the valve within the microfluidic devices.

Therefore, it is an object of the present invention to provide a connector to improve and where possible overcome the issues as discussed above.

### SUMMARY

The present invention provides a connector for being inserted into a first channel of a microfluidic device. The connector includes a first end and a second end, when seen in the direction of a longitudinal central axis of said connector, wherein the second end is arranged in a second end portion of the connector; an inner hollow space; a closed outer circumferential wall extending around said longitudinal central axis, such that said outer circumferential wall extends around said inner hollow space. The outer circumferential wall has at least two different outer diameters along said longitudinal central axis, which outer diameters differ in their value; and the outer surface of said circumferential wall is rotationally symmetrical with regard to said longitudinal central axis; an opening provided in said first end for receiving an insert, for example a hollow insert, and being in fluid connection with said inner hollow space; and a membrane sealingly covering said inner hollow space towards said second end of the connector. The insert is configured to provide pressure on said membrane. For example, the insert may be configured to selectively provide one of a positive pressure and a negative pressure on said membrane. The insert may be configured to provide pressure on said membrane such that a gas is supplied via said insert into said inner hollow space, wherein the gas pressure acts on said membrane. In an alternate embodiment, the insert may be configured to provide pressure on said membrane such that the insert directly contacts and presses on said membrane.

Said connector may be made from resilient material such that said connector is extendable in the direction of the longitudinal central axis by filling said inner hollow space with a pressurized fluid through said opening provided in said first end, so as to enlarge the maximum distance between said first end and at least a portion of said second end portion for blocking a second channel of the microfludic device by extending said portion of said second end portion into said second channel and/or retractable with regard to the direction of the longitudinal central axis by removing fluid from said inner hollow space through said opening provided in said first end, so as to reduce the maximum distance between said first end and at least a portion of said second end portion for unblocking a second channel of the microfludic device by removing said portion of said second end portion from said second channel. The connector may be easily inserted into the microfluidic device during manufacturing without the complexity in fabrication. In addition, the connector may be used as a valve for controlling fluid flow in the microfluidic device and when the membrane is ruptured, be used as a connector. This allows a more versatile use of the microfluidic device and provides greater flexibility for a user.

Said connector may be one-pieced. This eliminates any assembling step required to fabricate the connector.

The connector may have a first outer diameter of the connector, which first outer diameter is given at said first end, is smaller than a second outer diameter of the connector, which second outer diameter is given at said second end. This profile of the connector ensures that the connector is better secured within the microfluidic device and provides greater sealing effect of the connector.

Each of said first and second outer diameters may be larger than a third outer diameter of the connector, which third outer diameter is given between said first and second outer diameters, when seen along said longitudinal central axis. This profile of the connector ensures that the connector is better secured within the microfluidic device and provides greater sealing effect of the connector.

A first end portion of said connector, which first end portion comprises said first end, may form a flanged end of said connector. This profile of the connector ensures that the connector is better secured within the microfluidic device and provides greater sealing effect of the connector.

Said connector may have the shape of a truncated cone. This profile of the connector ensures that the connector is better secured within the microfluidic device and provides greater sealing effect of the connector.

Said inner hollow space may have the shape of a truncated cone.

Said inner hollow space may be formed by a channel having a constant diameter.

Said inner hollow space may be rotationally symmetrical with regard to said central axis. This profile of the connector ensures that the connector is better secured within the microfluidic device and provides greater sealing effect of the connector.

Said membrane may be located in the second end portion and/or at the second end of the connector.

The connector may be made of and/or consists of elastomeric material. This allows the connector to be resilient and compressible to provide a better sealing effect.

The present invention further provides a method of injecting a fluid into a microfluidic device by means of a connector as described above. The microfluidic device includes a substrate having a first channel therein. The method includes inserting said connector into said first channel; inserting a hollow insert having an outer diameter that is larger than an inner diameter of said opening and/or of said inner hollow space of said connector into and/or through said opening and/or into said inner hollow space so as to radially extend the outer circumferential wall with regard to the longitudinal axis of the insert, so that the connector forms an interference fit with said first channel of said microfluidic device; piercing or cutting or removing said membrane so as to provide a through channel within said connector; and injecting the fluid from a fluid supply into said opening, and via said through channel and into the microfluidic device.

The step of piercing said membrane may be performed by means of said hollow insert.

According to another aspect, the hollow insert may have a pointy end, and wherein said pointy end of said hollow insert is used for piercing said membrane.

The present invention further provides a method of providing and operating a valve device for blocking and/or unblocking a fluid flow through a second channel of a microfluidic device, the method using a connector as described above, wherein the microfluidic device further includes a substrate and a first channel provided in said substrate, and wherein said first channel leads into said second channel, the method includes providing said connector in said first channel; connecting the opening of the connector to a fluid source; and applying pressurized fluid in or into the inner hollow space of the connector such that the distance between the first end and at least a portion of the second end portion of the connector increases such that at least a portion of the second end portion of the connector extends into the second channel, so as to block fluid flow through said second channel and/or removing fluid from the inner hollow space of the connector such that the distance between the first end and a portion of the second end portion of the connector is reduced such that at least a portion of the second end portion of the connector is removed from the second channel, so as to unblock fluid flow through said second channel.

The method may further include the step of removing the pressurized fluid from the inner hollow space so that the distance between the first end and the second end portion of the connector reduces again, and fluid flow through said second channel is again enabled. Said removing may be performed by suction via said opening of said connector.

The step of connecting the opening of the connector to a fluid source may include the step of inserting a hollow insert into and/or through the opening and/or into said inner hollow space.

Said second channel may extend perpendicular to said first channel. According to another embodiment, said second channel may have a first branch that is perpendicular to said first channel, and a second branch the axis of which coincides with the axis of said first channel.

The hollow insert may be inserted into and/or through the opening and/or into said inner hollow space such that there is a fluid tight connection between said hollow insert and said connector.

Said hollow insert may be a pipe.

Said first channel may have at least two different diameters along its longitudinal axis.

The inner surface of the first channel may be stepped along its longitudinal axis, so that there are two or more than two sections along its longitudinal axis, with each of these sections having constant diameter wherein different sections have different diameters.

Said connector may be positioned such that it is surrounded by at least two different diameters of the first channel.

Said first channel may be constant in diameter.

The present invention further provides a method of providing and operating a valve device for blocking and/or unblocking a fluid flow through a second channel of a microfluidic device, the method using a connector according to the present invention, wherein the microfluidic device further comprises a substrate and a first channel provided in said substrate, and wherein said first channel leads into said second channel, the method includes providing said connector in said first channel; inserting an insert into the opening of the connector, moving one end of said insert towards said membrane of said connector, and loading said membrane of said connector by means of said insert, so as to extend said membrane into said second channel so as to block a fluid flow through said second channel of said microfluidic device.

The inventor reserves the right to draft further claims directed to a microfluidic device having a connector according to the present invention.

### DESCRIPTION OF FIGURES

Referring to the figures, some exemplary embodiments of the invention are described in the following.

FIG. 1 shows a sectional view of an exemplary microfluidic device having an exemplary connector according to the invention;

FIG. 2 shows a sectional, view of the microfluidic device of FIG. 1 having a hollow insert;

FIG. 3 shows a sectional view of another exemplary embodiment of the connector according to the invention, arranged in an exemplary microfluidic device, wherein other parts, i.e. all parts except the connector may be designed as explained with regard to FIG. 1;

FIG. 4a-4g shows a sectional view of various exemplary embodiments of the connector according to the invention, which may be arranged according to FIG. 1 or according to FIG. 3, for example;

FIG. 5 shows a sectional view of another exemplary embodiment of the connector according to the invention, which may be arranged according to FIG. 1 or according to FIG. 3, for example;

FIG. 6 shows a sectional view of the microfluidic device with an exemplary connector according to the present invention, which connector blocks a channel;

FIG. 7a shows an exemplary method for providing and operating a valve device using an exemplary connector according to the present invention, like any one of the connectors in FIG. 1-6;

FIG. 7b shows an exemplary inserting step of the connecting step in the method in FIG. 7a;

FIG. 8 shows a sectional view of the microfluidic device in FIG. 1 with hollow insert (with pointy end) piercing the membrane;

FIG. 9 shows a sectional view of the microfluidic device in FIG. 1 with hollow insert (flat end) piercing the membrane;

FIG. 10 shows an exemplary method of injecting fluid into the microfluidic device via an exemplary connector according to the present invention, like any one of the connectors in FIG. 1-6, according to the present invention;

FIG. 11 shows a sectional view of the microfluidic device having two channels and an exemplary connector according to the present invention, like any one of the connector in FIG. 1-6;

FIG. 12 shows a sectional view of the microfluidic device in FIG. 11 with retracted membrane;

FIG. 13 shows a sectional view of the microfluidic device in FIG. 3 without hollow insert;

FIG. 14 shows a table of manufacturing processes and materials for fabricating microfluidic device of FIG. 1;

FIG. 15 shows a sectional view of a microfluidic device having a connector on its side;

FIG. 16 shows a sectional view of a microfluidic device of FIG. 15 with a hollow insert;

FIG. 17a-17b shows a various arrangement of a plurality of microfluidic devices;

FIG. 17c shows 4″ diameter PMMA substrates having 16 chips with embedded connectors within;

FIG. 18 shows a chart showing the average pressure levels for direct needle and tubing interfacing after 10 pressure runs;

FIG. 19 shows a table showing average leakage pressure data for direct needle or tubing connection to the connector in any one of FIG. 1-6;

FIG. 20 shows a further exemplary embodiment of the present invention.

### DETAILED DESCRIPTION

FIG. 1 shows a sectional view of an exemplary microfluidic device 10 according to the present invention, which device 10 has an exemplary connector 100 according to the present invention, which connector 100 is inserted or embedded into a microfluidic device 10. Connector 100 has a membrane 200 attached to the connector 100. Said connector 100 and said membrane 200 may be produced as separate parts, and may then be fixed to each other, or said connector 100 and said membrane 200 may be produced as one-pieced.

Microfluidic device has a substrate 300. The substrate 300 has a top surface 302 on one side of the substrate 300 and a bottom surface 304 on the opposite side of the substrate 300. As shown in FIG. 1, the substrate 300 has a first channel 310 which extends from the top surface 302 towards the bottom surface 304 of the substrate 300. The substrate 300 has a second channel 320 within the substrate 300. Second channel 320 extends substantially parallel to and between the top surface 302 and the bottom surface 304, e.g. in FIG. 1, the second channel 320 extends into the paper. The substrate 300 may compose of at least two layers. As shown in FIG. 1, the substrate 300 may have a first layer of substrate or coverslip 330 and a second layer of substrate or complementary layer 340 attached to the coverslip 330 such that the coverslip 330 is formed directly on top of the complementary layer 340 thus forming a laminated substrate 300. Complementary layer 340 of substrate 300 may have microfluidic structures such as channels 310, 320, bifurcations, reservoirs, etc. for receiving the fluid. Substrate 300, which includes the coverslip 330 and complementary layer 340, may be made of poly-methyl methacylate (PMMA), polycarbonate (PC), cyclic-olefin polymer (COP) or Cyclic-olefin copolymer (COC).

A second channel 320 may be positioned along a plane 306 within the substrate 300 where the coverslip 330 meets the complementary layer 340. The second channel 320 may be positioned immediately below the plane 306 for easy manufacturing. First channel 310 extends towards the bottom surface 304 of the substrate 300 and meets the second channel 320 such that first channel 310 leads into the second channel 320 so that fluid communication is possible between the first channel 310 and the second channel 320. First channel 310 may also be extended to the second channel 320 such that the second channel 320 may be arranged across the first channel 310. Second channel 320 may extend perpendicular to the first channel 310 (into the paper). Second channel 320 may also have a branch (not shown in FIG. 1) which extends across the first channel 310 at the position or intersection at which the first channel 310 leads into the second channel 320.

In FIG. 1, the first channel 310 may have at least two different diameters along its longitudinal axis 308. The difference in the diameter of the first channel 310 results in the first channel 310 to have a stepped profile (with at least one step) where the inner surface of the first channel 310 may be stepped along its longitudinal axis 308 so that there are two or more sections 312 along its longitudinal axis 308. Each of the sections 312 may have a constant diameter such that different sections have different diameters. As shown in FIG. 1, connector 100 may be positioned such that it is surrounded by at least two different diameter of the first channel 310. The diameter of the section 312 adjacent the top surface 302 may be larger than the diameter of the section 312 adjacent the bottom surface 304. The diameter of the section 312 adjacent the bottom surface 304 may be the same as or longer than the width of the second channel 320. The coverslip 330 and the complementary layer 340 may be aligned and bonded to each other so that the first channel 310 is aligned with the second channel 320 to allow fluid communication between the first channel 310 and the second channel 320. The first channel 310 may have a constant diameter.

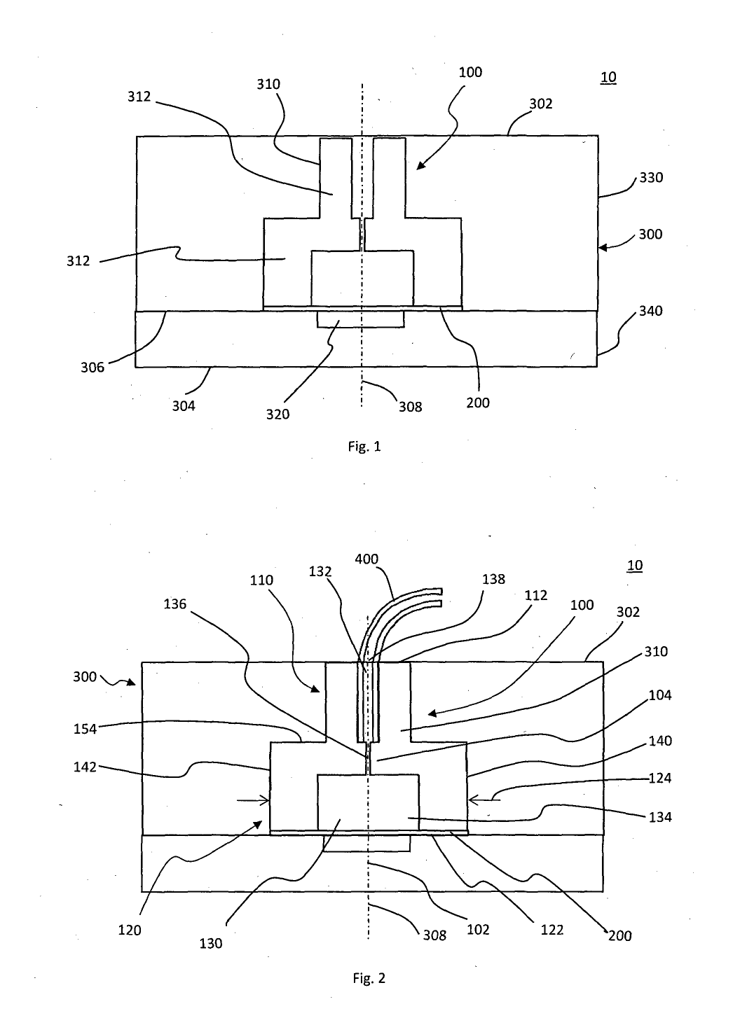

FIG. 2 shows a sectional view of the microfluidic device 10 with a hollow insert 400 inserted into the connector 100. Connector 100 has a first end portion 110 and a second end portion 120 adjacent to the first end portion 110. Connector 100 has a first end 112 and a second end 122, the second end 122 being the other end of the connector 100 when seen in the direction of a longitudinal central axis 302 of the connector 100, wherein the first end 112 is arranged in the first end portion 110 and the second end 122 is arranged in the second end portion 120 of the connector 100. Longitudinal central axis 302 may coincide with the longitudinal axis 308. Connector 100 has an inner hollow space 130 which may extend from the first end 112 to the second end 122 of the connector 100 and the longitudinal central axis 302 lies within the inner hollow space 130. Connector 100 has a closed outer circumferential wall 140 which extends around the longitudinal central axis 302. A closed outer circumferential wall 140 is a wall which completely surrounds the longitudinal axis 302. As shown in FIG. 2, the outer circumferential wall 140 extends around the inner hollow space 130. Outer circumferential wall 140 has an outer surface 142 which is rotationally symmetrical with regard to said longitudinal central axis 302. The outer circumferential wall 140 and inner hollow space 130 may form concentric circles when viewed from the top of the connector 100 along the longitudinal central axis 302 towards the second end 122.

Outer circumferential wall 140 has at least two different outer diameters along the longitudinal central axis, which the two outer diameters differs in their value. As shown in FIG. 2, the first outer diameter 114 may be given at the first end 112, e.g. the first outer diameter 114 may be the outer diameter of the first end portion 110 or first end 112 and the second outer diameter 124 may be given at the second end 122, e.g. the second outer diameter may be the outer diameter of the second end portion 120 or second end 122. In FIG. 2, the first outer diameter may be smaller than the second outer diameter. The outer circumferential wall 140, having two different diameters 114,124, may have a stepped profile when viewed from the side of the connector 100. Depending on the difference in outer diameters 114,124, the width of the step may vary accordingly.

Although a stepped side profile of the connector 100 is shown, the side profile of the connector 100 may vary as long as the profile allows the retention of the connector 100 within the substrate 300. As shown in FIG. 4a, connector 100 may have a gradient portion 150 where the outer circumferential wall 140 extends linearly away from the inner hollow space 130 from the first end 112 to the second end 122 such that the connector 100 has the shape of a truncated cone or frusto-conically shape. In FIG. 4b, the connector 100 may have a stepped portion 154 between the first outer diameter 114 and the second outer diameter 124, similar to that of the connector 100 in FIG. 1. Connector 100 may have a combination of a linear portion 152 and gradient portion 150 as shown in FIG. 4c. Linear portion 152 may be a cylinder in the 3D perspective. As shown in FIG. 4d, the side profile of the connector 100 may have a curved portion 156 extending radially away from the inner hollow space 130 forming a “bell-bottom” profile where the outer diameter of the curved portion increases at an increasing rate towards the second end 122 of the connector 300. The gradient and curved portions 150,156 allow the connector 100 to be better secured to the substrate 300 and provide a better sealing effect for the connector 100 between the connector 100 and the substrate 300 and between the connector 100 and the hollow insert 400 when pressure builds up in the first channel 310 and/or second channel 320. When the pressure in the microfluidic device 10 builds up and presses onto the second end 122 of the connector 100, the connector 100 may be compressed against the substrate 300 and “squeeze” the connector 100 against the substrate 300 and funnels the connector 100 towards the top surface 302 of the microfluidic device 10 thereby “choking” the connector 100 against the substrate 300 to more securely containing the connector 100 within the substrate 300. Connector 100, being compressed, exerts pressure laterally or perpendicularly to the longitudinal central axis 302 against the substrate 300 and the hollow insert 400 thereby enhancing the sealing effect of the connector 100 against the substrate 300 and the hollow insert 400.

As shown in FIGS. 4a-4d, the first outer diameter 114 at the first end 112 may be smaller than the second outer diameter 124 at the second end 122 of the connector 100. Outer circumferential wall 140 may be in a concentric arrangement with the inner hollow space 130.

FIGS. 4e-4g shows the first outer diameter 114 at the first end 112 and second outer diameter 124 at the second end 122 of the connector 100, each diameter may be larger than a third outer diameter of the connector 100. Third outer diameter 144 is given between the first outer diameter 114 and the second outer diameter 124, when seen along the longitudinal central axis 302. As shown in FIG. 4e-4g, the first end portion 110 of the connector 100 may have a first end 110 which forms a flanged end 116 of the connector 100. Connector 100 may have a stepped portion 154 or a gradient portion 150 between the first outer diameter 114 and the third outer diameter 144 such that the flanged portion 116 may be formed from the stepped or gradient portion 154,150 adjacent the first end 112.

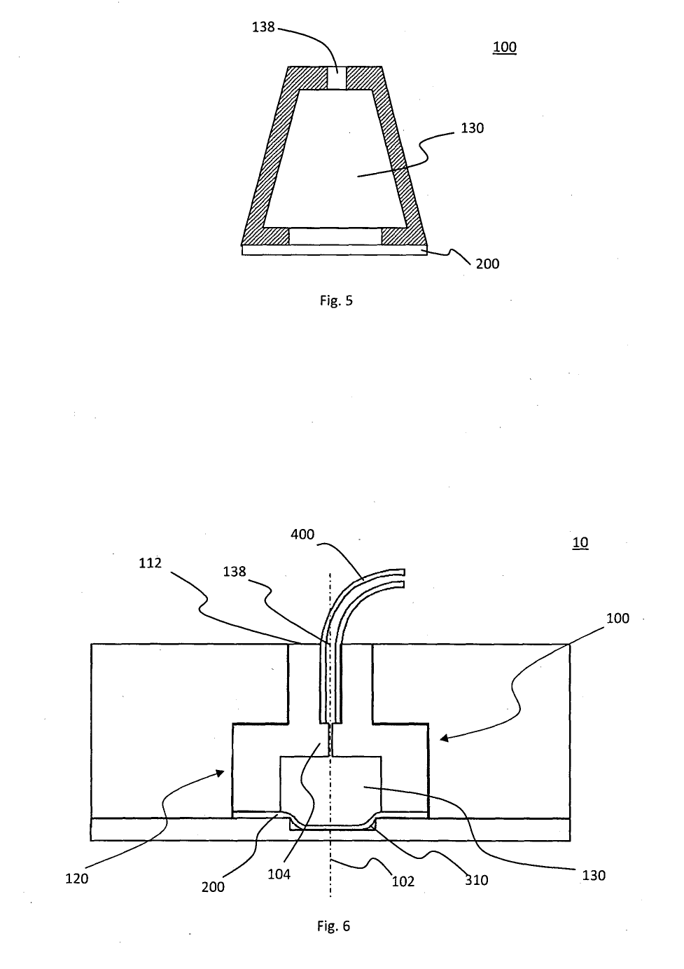

As shown in FIG. 2, inner hollow space 130 may be rotationally symmetrical about the longitudinal central axis 302. As shown in FIG. 2, inner hollow space 130 may have a first inner portion 132 and a second inner portion 134, the first and second inner portions 132,134 may be separated by a spacer 104 having a connecting channel 136 and the first and second inner portions 132,134 may be connected to each other via the connecting channel 136 such that the first inner portion 132, the second inner portion 134 and the connecting channel 136 forms the inner hollow space 130 and the first inner portion 132 is in fluid communication with the second inner portion 134. In FIG. 2, the first inner portion 132 may have a diameter which is smaller than the diameter of the second inner portion 134. The difference between the diameters of the first and second inner portion 132,134 may correspond to the difference between the first and second outer diameter of the outer circumferential wall 140 such that as the first outer diameter of the outer circumferential wall 140 is smaller than the second outer diameter of the circumferential wall 140, the diameter of the first inner portion 132 is correspondingly smaller than the diameter of the second inner portion 134. Inner hollow space 130 has an opening 138 for receiving the hollow insert 400. Opening 138 is provided in the first end 112 and is in fluid connection with the inner hollow space 130. As shown in FIG. 2, the opening 138, the first end 112 of the connector 100 and the top surface 302 of the substrate 300 may be flush with each other. For a connector 100 having a truncated coned shaped as shown in FIG. 4a, the inner hollow space 130 may also be in the shape of a truncated cone or frusto-conically shaped as shown in FIG. 5. As shown in FIG. 5, connector 100 may have a substantially constant thickness between the outer circumferential wall 140 and the inner hollow space 130. As shown in FIG. 4a-4g, the inner hollow space 130 may be formed by a channel having a constant diameter, e.g. a cylinder. Inner hollow space 302 as shown in FIG. 4a-4g may have a constant diameter throughout. The profile of the inner hollow space 130 may vary to include any other shapes and profiles, e.g. in FIG. 1.

Each section of the outer circumferential wall 140 of the connector 100 may have a diameter that is greater or marginally greater than the internal diameter of the first channel 310 of a corresponding section such that there may be an interference fit maintained between the connector 100 and the first channel 310. As there may be several sections on the connector 100 and in the first channel 310, the following description may refer to one section or the subject, e.g. connector 100 or first channel 310 itself, for simplicity but is relevant to all the sections of the connector 100 and first section 310 along the respective longitudinal axis 308, 302. The interference fit between the connector 100 and the first channel 310 provides a sealing effect between the connector 100 and the first channel 310. In addition, there may be an interference fit between the inner hollow space 130 of the connector 100 and the hollow insert 400 such that the external diameter of the hollow insert 400 may be greater or marginally greater than the internal diameter of the inner hollow space 130 to form the interference fit. Similarly, the interference fit between the connector 100 and the hollow insert 400 enhances the sealing effect between the connector 100 and the hollow insert 400.

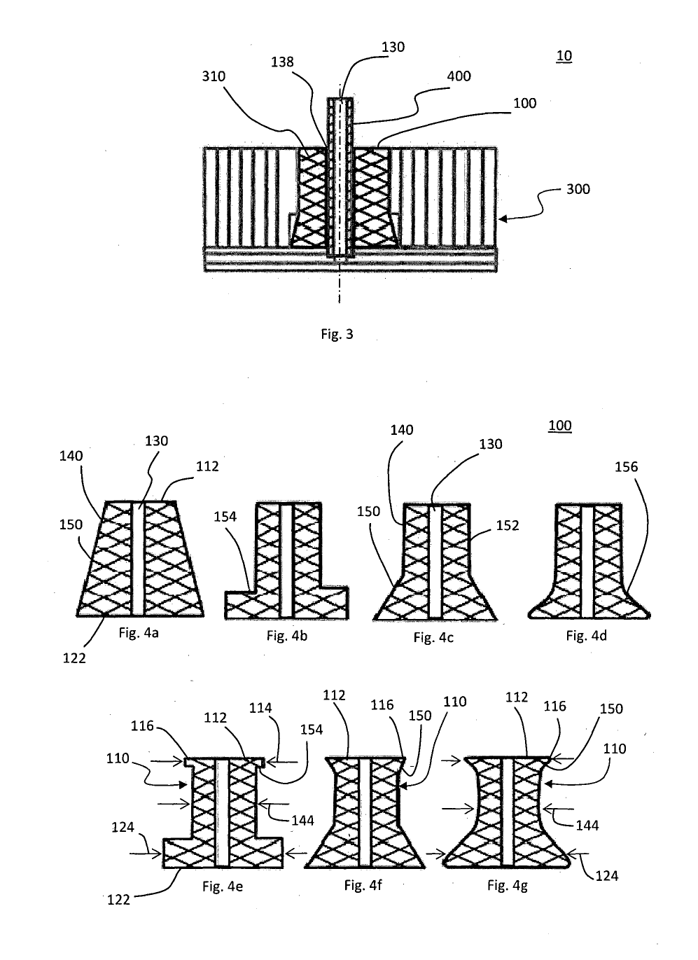

Due to the difference between the diameters, e.g. external diameter of outer circumferential wall of the connector 100 and internal diameter of the first channel 310, it can be understood by a skilled person in the art that by inserting the hollow insert 400 into the opening 138 and/or the inner hollow space 130, the hollow insert 400 may enlarge the opening 300 or expand the first channel 310, i.e. increase their respective diameters, thus forming an interference fit. By expanding the first channel 310, the connector 100 may consequently expand into the first channel 310 thereby compressing the connector 100 between the substrate 300 and the hollow insert 400 as shown in FIG. 3. The compression of the connector 100 improves the sealing effect of the connector 100 with respect to the first channel 310 and the hollow insert 400. For a connector 100 with a cylindrical type inner hollow space 130, the interference fit may be formed between the hollow insert 400 and the opening 138 and/or inner hollow space 130. However, for a connector 100 with an inner hollow space 130 larger than the opening 138, the interference fit may be formed between the hollow insert 400 and the opening 138.

As shown in FIG. 3, and applicable to the other embodiments, the second channel 320 may have a width and the width of the second channel 320 may correspond with the external dimension or diameter of the hollow insert 400 so that one end of the hollow insert 400 may fit into the second channel 320 when fully inserted into connector 100.

Referring to FIG. 2, membrane 200 is located in the second end portion 120 and/or second end 122 of connector 100 and sealingly covers the inner hollow space 130 towards the second end 122 of the connector 100. Connector 100 and the membrane 200 may be integrally formed and thus the connector 100 may be one-pieced. Membrane 200 is made from a resilient material such that the connector 100 is extendable in the direction of the longitudinal central axis 302.

As shown in FIG. 6, hollow insert 400, which is received in the opening 138, may be connected to a fluid source (not shown in FIG. 6) which is capable of supplying pressurised fluid into the microfluidic device 10. Connector 100 is extendable in the direction of the longitudinal central axis 302 by filling the inner hollow space 130 with pressurised fluid through the opening 138 provided in the first end 112, so as to enlarge the maximum distance between the first end 112 and at least a portion of the second end portion 120 to extend the connector 100. As shown in FIG. 6, when pressurised fluid is injected from the fluid source into the inner hollow space 130, which may be into the second inner portion 134, the membrane 200 is pushed in the direction of the longitudinal central axis 302 and into the second channel 320. By extending the portion of the second end portion 120 of the connector 100, i.e. by pushing the membrane 200 into the second channel 320, the second end portion 120 blocks the second channel 320 from any fluid flow along the second channel 320. As shown in FIG. 6, hollow insert 400, when being inserted into the inner hollow space 130 may abut against the spacer 104 so that the insertion of the hollow insert 400, when used to inject pressurised fluid into the connector 100 to expand the connector 100, may be stopped by the spacer 104.

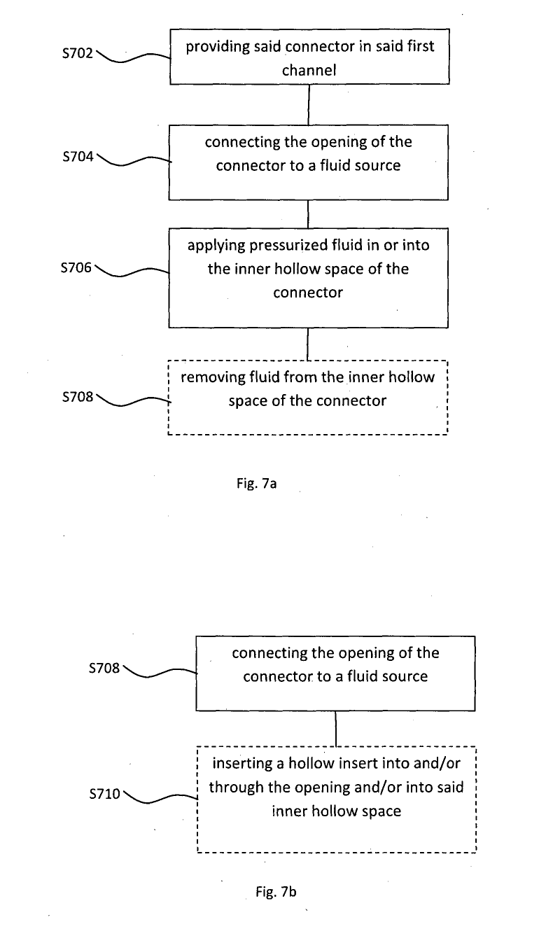

As described above and as shown in FIG. 6, FIG. 7a shows the steps of use of the connector 100 as a valve. Connector 200 may be used as a valve by providing the connector 100 in the first channel 310 as shown in step S702, connecting the opening 138 of the connector 100 to the fluid source in step S704 and applying pressurised fluid in or into the inner hollow space 130 of the connector 100 in step S706 such that the distance between the first end 112 and at least a portion of the second end portion 120 of the connector 100 increases so that at least a portion of the second end portion 120 of the connector 100 extends into the second channel 320 so as to block fluid flow through the second channel 320. As shown in FIG. 7b, by connecting the opening 138 of connector 100 to the fluid source in step S704, the step includes inserting a hollow insert 400 into and/or through the opening 138 and/or into the inner hollow space 130 in step S710. Due to the interference fit between the opening 138 and/or inner hollow space 130, the hollow insert 400 when inserted into and/or through the opening and/or into the inner hollow space 130, there is a fluid tight connection between the hollow insert 400 and the connector 100.

Upon extending the connector 100 by increasing the distance between the first end 112 and the second end portion 120, i.e. extending the membrane 200, along the longitudinal central axis 302 into the second channel 320, to block the fluid flow in the second channel 320, it is possible to “unblock” the second channel 320 to enable fluid flow through the second channel 320 again by removing the pressurised fluid from the inner hollow space 130 as shown in step S708 in FIG. 7a so that the distance between the first end 112 and the second end portion 120 of the connector 100 may be reduced again (see FIG. 1).

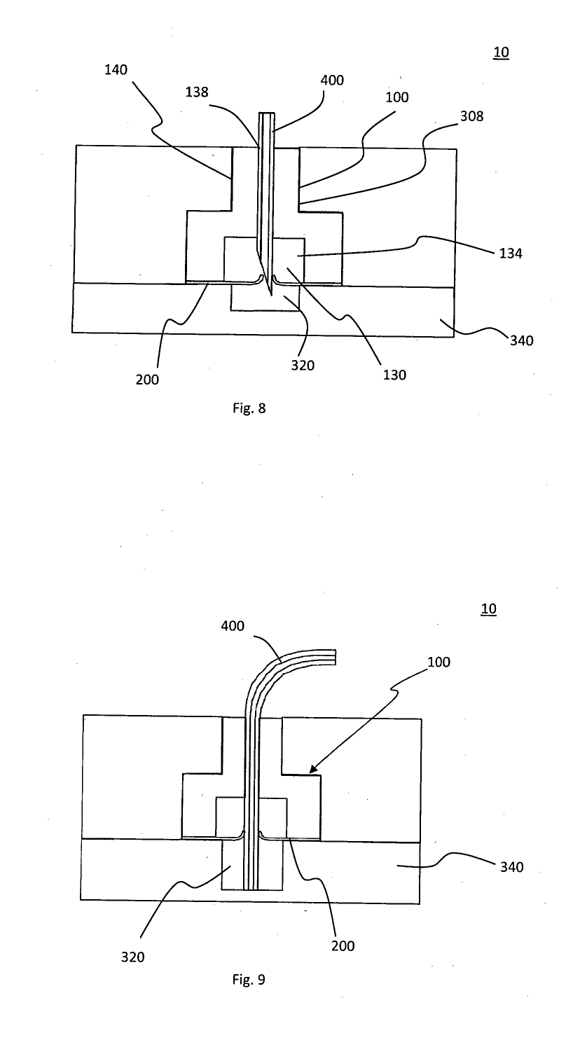

However, as shown in FIG. 8, connector 100 may also be used to connect a hollow insert 400 to the microfluidic device 10 for injecting a fluid into the microfluidic device 10. In order to retain the hollow insert 400 in the microfluidic device 10 (as with the other embodiments), the external diameter of the hollow insert 400 is larger than the internal diameter of the opening 138 and/or of the inner hollow space 130 so that the hollow insert 400 radially extends the outer circumferential wall 140 with regard to the longitudinal axis of the hollow insert 400 when the hollow insert 400 is inserted the inner hollow space 130. When this happens, connector 100 forms an interference fit with the first channel 310 of the microfluidic device 10. To inject the fluid, hollow insert 400 may be inserted beyond the spacer 104 (not shown in FIG. 8) and into the second inner portion 134. Hollow insert 400 may be used to pierce or puncture the membrane 200 to allow fluid communication to be established between the hollow insert 400 and the second channel 320 so as to allow pressurised fluid to flow from the fluid supply into the microfluidic device 10. In FIG. 8, it is shown that the complementary layer 340 of the substrate 300 may have a relatively shallow second channel 320 within. As shown in FIG. 8, the hollow insert 400 may have a pointy end 402 for piercing the membrane 200. A shallow second channel 320 is possible for a hollow insert 400 with a pointy end 402 as shown in FIG. 8. However, as shown in FIG. 9, if a hollow insert 400 with a flat end 404, e.g. a pipe, is used to pierce the membrane 200 of the connector 100, a complementary layer 340 with a deeper second channel 320 may be preferred. With more depth, membrane 200 can be further extended when the hollow insert 400 is pressed against the membrane 200 to extend the membrane 200 beyond its elastic limits to rupture and thus pierce the membrane 200.

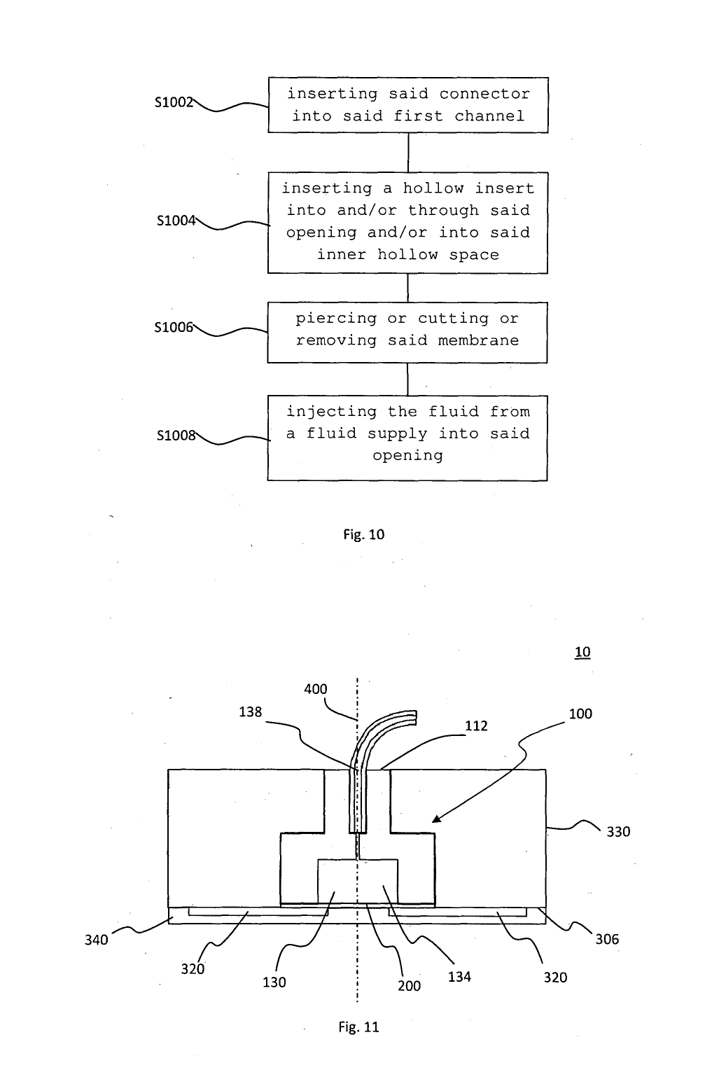

As shown in FIG. 10, to inject a fluid into the microfluidic device 10 by means of the connector 100, connector 100 is being inserted into the first channel 310 as shown in S1002. As in step S1004, hollow insert 400 is then being inserted into and/or through the opening 138 and/or into the inner hollow space 130 to radially extend the outer circumferential wall 140 to form an interference fit between the connector 100 and the first channel 310. Thereafter, membrane 200 is pierced, cut or removed so as to provide a through channel within the connector in step S1006. Once, the through channel is provided, fluid from the fluid supply is injected into the opening 138 and via the through channel and into the microfluidic device 10 as seen in step S1008. Although the steps S1002-S1006 are described in the order above, the sequence of the steps need not be in the described order, e.g. membrane 200 may first be pierced by a foreign object before inserting the hollow insert 400 through the opening 138 or into the inner hollow space 130. Therefore, it can also be understood by a skilled person that the piercing step S1006 need not be performed by means of the hollow insert 400.

Besides increasing the maximum distance between the first end 112 and the second end portion 120 of the connector 100, the distance between the first end 112 and the second end portion 120 of the connector 100 may also be reduced by retracting the membrane 200. As shown in FIG. 11, connector 100 may be inserted between and onto two second channels 320 that are along the same plane 306 at the interface of the coverslip 330 and the complementary layer 340 but spaced apart from each other. The spacing between the two second channels 320 is narrower than the internal diameter of the second inner portion 134 of the inner hollow space 130 such that the second inner portion 134 extends over the edge of each of the two second channels 320. It can be seen in FIG. 11 that, without the membrane 200, fluid may be able to flow from one of the two second channels 320 into the second inner portion 134 of the inner hollow space 130 and into the other of the two second channels 130. With the membrane 200 in place, the connector 100 blocks fluid communication between the two second channels 320. As shown in FIG. 11, the hollow insert 400 may also be inserted into the opening 138 and/or inner hollow space 130 of the connector 100.

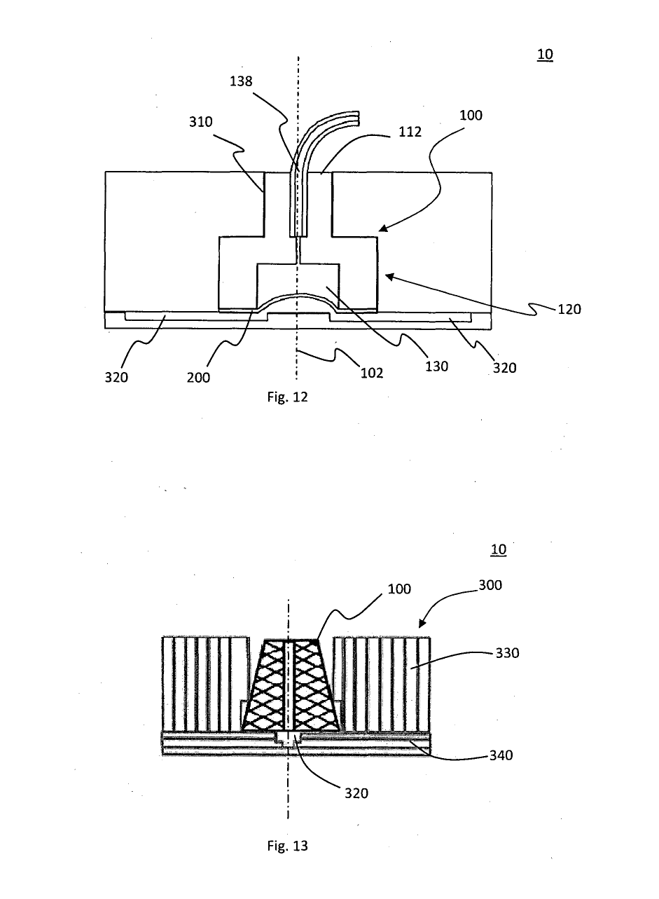

To unblock fluid flow between the two second channels 320, as shown in FIG. 12, membrane 200 may be retractable with regard to the direction of the longitudinal central axis 302 by removing fluid, e.g. air, from the inner hollow space 130 through the opening 138 provided in the first end 112, so as to reduce the maximum distance between the first end 112 and at least a portion of the second end portion 120. By retracting the membrane 200, the second channel 320 of, the microfluidic device is unblocked by removing the portion of the second end portion 120 from the second channel 320. When unblocked, fluid flow may be established between the two second channels 320.

Although it was earlier mentioned that the stepped portion 154 of the connector 100 may correspond to the stepped profile of the first channel 310, a gradient portion 150 or any non stepped portion, e.g. curved portion 156, of the connector 100 as shown in FIG. 4a-4d may also be used for the stepped profile of the first channel 310. FIG. 13 shows a connector 100 with a gradient portion 150 within a step profiled first channel 310.

Connector 100 may be made of and/or consist of elastomeric or rubber materials such as polydimethylsiloxane (PDMS), flourosilicone rubber, polyacrylic rubber, thermoplastic elastomer (TPU), nitrile rubber, Viton®, silicone elastomers, etc. Typically the elastomeric or rubber materials may have a Young Modulus value ranging from 1 MPa to 30 MPa. Preferably, the value may be from 5 MPa to 25 MPa or 10 MPa to 20 MPa. Connector 100 may be suitable for use in hard or thermoplactic microfluidic devices 10.

Microfluidic structures within microfluidic devices 10 may be manufactured through methods such as micro-injection molding, micro-milling, laser machining, thermal embossing or casting. First channel 310 in the substrate 300 and the microfluidic structures in the bottom complementary layer 340 may be structured using micro-injection molding, micro-milling, laser machining, thermal embossing or casting.

Connector 100 may be manufactured through punching, casting or forming techniques. For example, connector 100 may be formed through a two step process with includes punching, i.e. to punch out a frusto-conical profile, and coring, i.e. to core out the inner hollow space 130 within the centre of connector 100. The diameter of the inner hollow space 130 may be adjusted to accommodate the outer diameter of the hollow insert 400 to be inserted to provide an interference fit.

To assemble the microfluidic device 10, the connector 100 may be embedded within the microfluidic device 10 by pick-and-place methods. Once the connectors 300 are embedded within the microfluidic device 10, the connector 100 may be flush with the top surface of substrate 300 where the hollow insert 400 enters the opening 138. Alignment of the coverslip 330 to the complementary layer 340 may be achieved manually, through microscopic visualization or auto-alignment tools. Once aligned, the coverslip 330 and complementary layer 340 may be bonded together. Bonding of the coverslip (with connectors) and the complementary layer can be achieved through bonding methods such as thermal bonding, solvent-assisted bonding, ultrasonic or laser welding, tape, glue or epoxy bonding. Embedding of the connector 100 is complete when the coverslip 330 containing the connector 100 is aligned and bonded to the complementary layer 340 with microfluidic structures. It should be noted that besides the standard fabrication steps used to manufacture the thermoplastic microfluidic device 10, no other manufacturing processes may be necessary to embed the elastomeric connector 100 within the microfluidic device 10. As shown, the fabrication of the microfluidic device 10 has been greatly simplified by the simple assembling of the connector 100 and the substrate by inserting the connector 100 into the coverslip 330 of the substrate 300 before bonding the coverslip 330 and complementary layer 340.

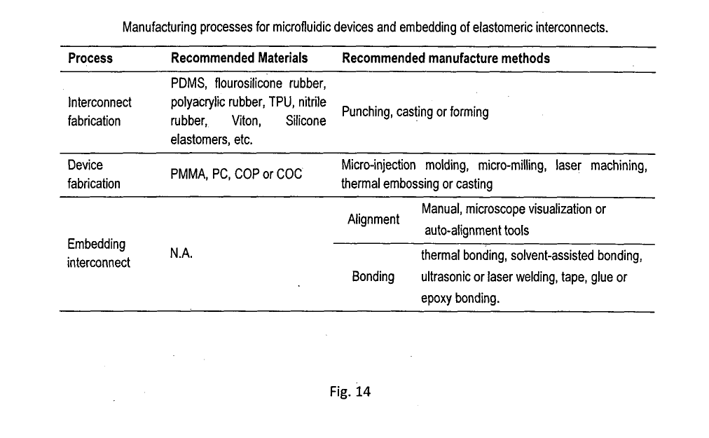

The manufacturing processes that are required to form microfluidic devices 10 and therein embed the connectors 300 may be summarized in FIG. 14.

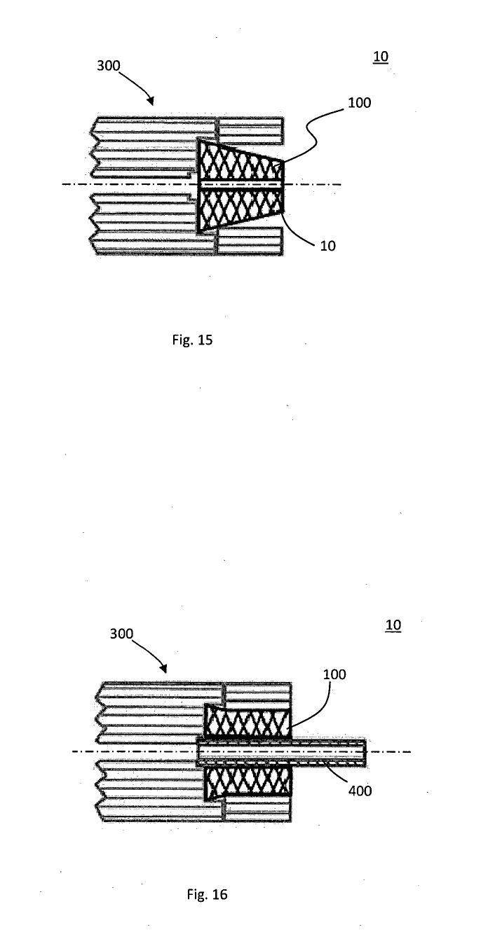

Although it has been shown that the connector 100 may be embedded for top hollow insert access as shown in FIGS. 1-13, it may be possible for connector 100 to be embedded for side hollow insert access as shown in FIGS. 15 and 16.

Hollow inserts 400 may include capillary tube, pipe, hard or flexible tubing, needles, or pipettes. Inserts 400 may further include non-hollow inserts 402 as shown in FIG. 20. Inserts 402 may be rounded. Such rounded inserts, designed as rounded pins, for example, may deform the membrane 200 without piercing or cutting it.

Successful embedding of the connector 100 enables a direct “plug-and-play” configuration between microfluidic devices 10. In this way, hollow insert 400, e.g. tubings, may be plugged directly into the opening 138 to allow fluid flow between microfluidic devices. At the same time, the sealing effect between the connector 100 and the substrate 300 as well as between the connector 100 and the hollow insert 400 may be robust enough to withstand conventional pressure used for the microfluidic device. It can be seen that present microfluidic device 10 including the connector 300 provides a quick and convenient way of connecting and disconnecting hollow insert 400 into and from the connector 100.

Another advantage the present connector 100 is the ability of the connector 100 to be used for connecting a hollow insert 400 or as a valve. Having a dual function of the connector 100 reduces the need to fabricate two separate parts for a connector and a valve. Consequently, the microfluidic device allows a connector 100 to be used either as a connector for insertion of fluid or valve for blocking and unblocking of second channel so as to increase the flexibility of use of the microfluidic device 10.

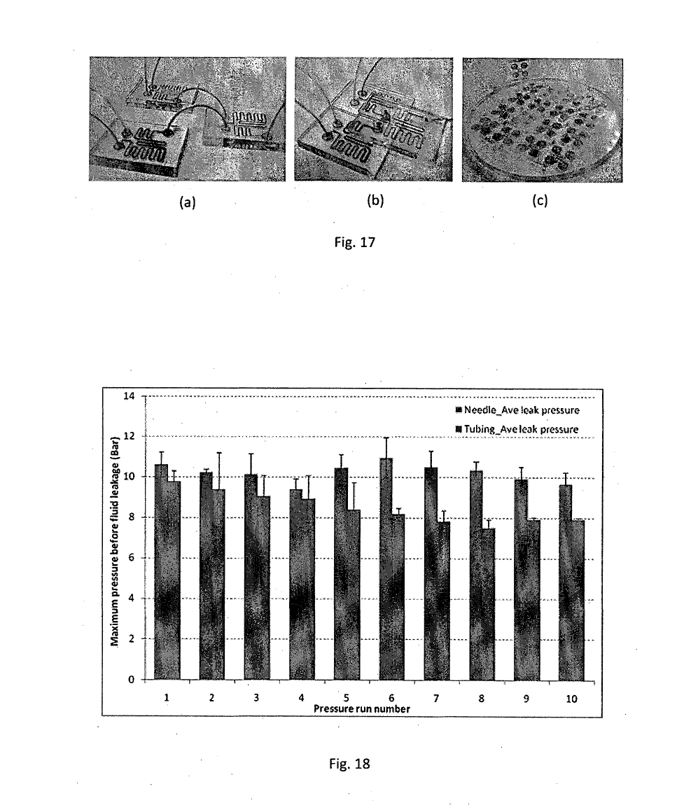

As mentioned, the connector 100 may be found to operate leak-free under pressure due to the flow driven through tubings by pumps. Due to the leak-free interfacing, multiple microfluidic devices 10 may be connected to each other in a sequential manner directly using tubings (see FIG. 17a). Similarly, by utilizing short flat flanged needles, multiple microfluidic devices 10 may be stacked onto one another (see FIG. 17b) while still maintaining their modular function of fluid flow mixing. Furthermore, the design scheme of the embedded connectors may be tested for manufacturability using two layers of 4″ diameter PMMA substrates containing 16 smaller microfluidic devices 10. FIG. 17c shows 16 chips that were manufactured with fully functional embedded connectors within 4″ diameter PMMA substrates.

In order to ascertain the robustness of the embedded connectors, fluid pressure test were conducted to determine the maximum positive and negative fluidic pressure that would be reached before any leaks occurred. Positive pressure tests were performed using a Harvard specialty syringe pump that could deliver pressures of up to 30 bars. The syringe pump was connected to a device with the embedded connectors directly using tubings or flat flanged needles. During pressure tests, all the outlets of the microfluidic device were blocked while the syringe pump continued to build up device pressure by pumping in fluid at a rate of 1 ml/min. After a leakage occurs at the connector, the needle or tubing was removed and re-attached to perform another pressure test. Ten sequential pressure tests were conducted on a single connector to determine the reusability of the connector. FIG. 18 shows the average pressure levels for direct needle and tubing interfacing after 10 pressure runs.

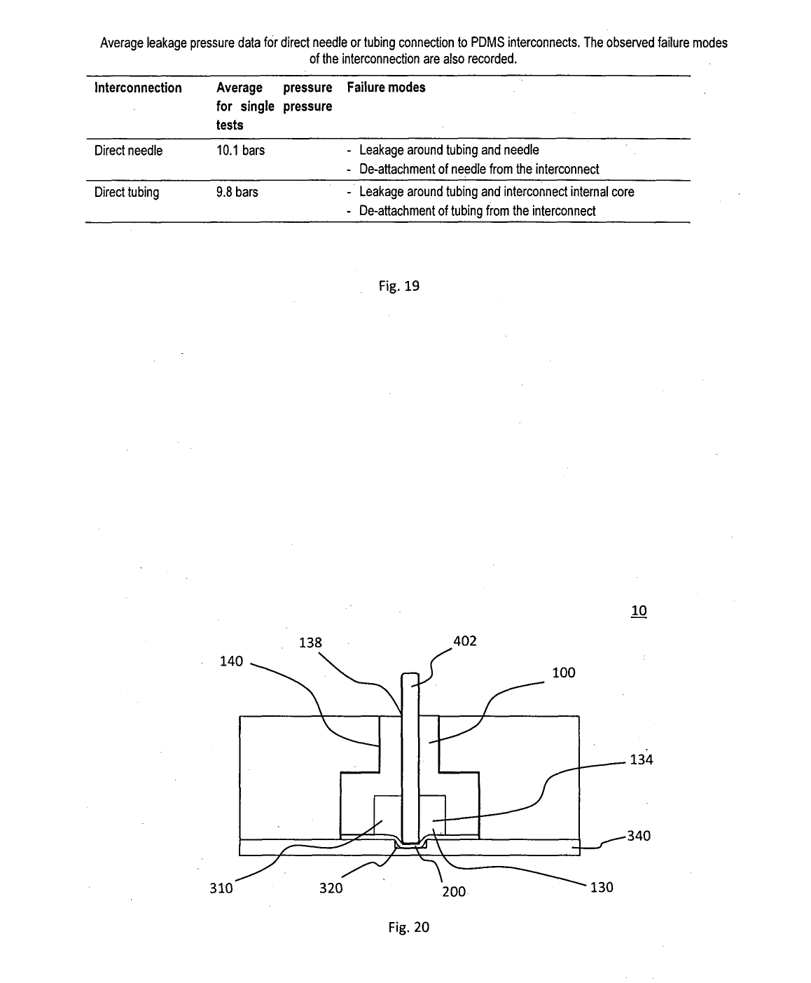

The average leakage pressures of embedded a connector 100 for singular pressure tests are also summarized in FIG. 19. The common failure modes observed are also summarized within Table 10. Based on the pressure test and experiment observations, it was found that upon hollow insert insertion, the elastomeric PDMS connector maintained a leak free interface with the adjacent microfluidic device areas. As the most common failure mode was between the hollow insert 400 and the connector 100; it can be deduced that the interface between the connector and microfluidic device may be extremely robust. Furthermore, a minimum fluid leakage pressure of about 9 bars may be more than sufficient for the majority of microfluidic applications as microfluidic applications typically operate at pressures below 2 bars.

The embodiment of a microfluidic device shown in FIG. 20 may be identical or similar to the one shown in FIG. 8. However, the insert 402 shown in FIG. 20 differs from the hollow insert 400 as shown in FIG. 8. In addition, the exemplary use of the device shown in FIG. 20 differs from the exemplary use of the device shown in FIG. 8. In other words, the exemplary method for which the device show in FIG. 20 is used differs from the exemplary method for which the device shown in FIG. 8 is used.

While in the device shown in FIG. 8, a hollow insert 400 having a pointy end is used for piercing the membrane 200, or fluid is supplied via the hollow insert 400 into the device, if used as a valve, the connector with the insert 402 as shown in FIG. 20 is used as a valve. Accordingly, insert 402 which may be made from solid material is inserted via opening 138 into the inner hollow space 130 of the connector 100 such that one end, i.e. the end inserted into connector 100, contacts and pushes the membrane 200. By loading the membrane 200 by means of the insert 402, the membrane 200 is deformed and extended into the second channel 320, thereby blocking fluid flow through the second channel 320.

By retracting the insert 402, which may be a rod, the membrane 200 moves back in its unloaded state and thus unblocks the second channel 320 so that fluid can flow there through.

1. A connector for being inserted into a first channel of a microfluidic device, wherein said connector comprises
a first end and a second end, when seen in the direction of a longitudinal central axis of said connector, wherein the second end is arranged in a second end portion of the connector;
an inner hollow space,
an outer circumferential wall extending around said longitudinal central axis, wherein
said outer circumferential wall extends around said inner hollow space;
said outer circumferential wall has at least two different outer diameters along said longitudinal central axis, which outer diameters differ in their value; and
the outer surface of said circumferential wall is rotationally symmetrical with regard to said longitudinal central axis;
an opening provided in said first end for receiving an insert and being in fluid connection with said inner hollow space; and
a membrane sealingly covering said inner hollow space towards said second end of the connector;
wherein the insert is configured to provide pressure on said membrane.

2. The connector according to claim 1, wherein said insert is a hollow insert and wherein said connector is made from resilient material such that said connector is extendable in the direction of the longitudinal central axis by filling said inner hollow space with a pressurized fluid through said opening provided in said first end, so as to enlarge the maximum distance between said first end and at least a portion of said second end portion for blocking a second channel of the microfludic device by extending said portion of said second end portion into said second channel and/or retractable with regard to the direction of the longitudinal central axis by removing fluid from said inner hollow space through said opening provided in said first end, so as to reduce the maximum distance between said first end and at least a portion of said second end portion for unblocking a second channel of the microfludic device by removing said portion of said second end portion from said second channel.

3. The connector according to claim 1, wherein the outer circumferential wall extending around said longitudinal central axis is a closed outer circumferential wall extending around said longitudinal central axis.

4. The connector according to claim 1, wherein each of said first and second outer diameters is larger than a third outer diameter of the connector, which third outer diameter is given between said first and second outer diameters, when seen along said longitudinal central axis.

5. The connector according to claim 1, wherein a first end portion of said connector, which first end portion comprises said first end, forms a flanged end of said connector.

6. The connector according to claim 1, wherein said inner hollow space is formed by a channel having a constant diameter.

7. The connector according to claim 1, wherein said inner hollow space is rotationally symmetrical with regard to said central axis.

8. The connector according to claim 1, wherein said membrane is located in the second end portion and/or at the second end of the connector.

9. A method of injecting a fluid into a microfluidic device by means of a connector as claimed in claim 1 wherein said microfluidic device comprises a substrate having a first channel therein, the method comprising:
inserting said connector into said first channel;
inserting a hollow insert having an outer diameter that is larger than an inner diameter of said opening and/or of said inner hollow space of said connector into and/or through said opening and/or into said inner hollow space so as to radially extend the outer circumferential wall with regard to the longitudinal axis of the insert, so that the connector forms an interference fit with said first channel of said microfluidic device;
piercing or cutting or removing said membrane so as to provide a through channel within said connector; and
injecting the fluid from a fluid supply into said opening, and via said through channel and into the microfluidic device.

10. The method of claim 9, wherein the step of piercing said membrane is performed by means of said hollow insert.

11. The method of claim 9, wherein hollow insert has a pointy end, and wherein said pointy end of said hollow insert is used for piercing said membrane.

12. A method of providing and operating a valve device for blocking and/or unblocking a fluid flow through a second channel of a microfluidic device, the method using a connector as claimed in claim 1, wherein the microfluidic device further comprises a substrate and a first channel provided in said substrate, and wherein said first channel leads into said second channel, the method comprising,
providing said connector in said first channel;
connecting the opening of the connector to a fluid source;
applying pressurized fluid in or into the inner hollow space of the connector such that the distance between the first end and at least a portion of the second end portion of the connector increases such that at least a portion of the second end portion of the connector extends into the second channel, so as to block fluid flow through said second channel and/or removing fluid from the inner hollow space of the connector such that the distance between the first end and a portion of the second end portion of the connector is reduced such that at least a portion of the second end portion of the connector is removed from the second channel, so as to unblock fluid flow through said second channel.

13. The method of claim 12, further comprising the step of removing the pressurized fluid from the inner hollow space so that the distance between the first end and the second end portion of the connector reduces again, and fluid flow through said second channel is again enabled.

14. The method of claim 12, wherein the step of connecting the opening of the connector to a fluid source includes the step of inserting a hollow insert into and/or through the opening and/or into said inner hollow space.

15. The method of 12, wherein said second channel extends perpendicular to said first channel.

16. The method of claim 12, wherein hollow insert is inserted into and/or through the opening and/or into said inner hollow space such that there is a fluid tight connection between said hollow insert and said connector.

17. The method of claim 12, wherein said hollow insert is a pipe.

18. The method of claim 12, wherein said first channel has at least two different diameters along its longitudinal axis.

19. The method of claim 18, wherein said connector is positioned such that it is surrounded by at least two different diameters of the first channel.

20. A method of providing and operating a valve device for blocking and/or unblocking a fluid flow through a second channel of a microfluidic device, the method using a connector as claimed in claim 1, wherein the microfluidic device further comprises a substrate and a first channel provided in said substrate, and wherein said first channel leads into said second channel, the method comprising,
providing said connector in said first channel;
inserting an insert into the opening of the connector, moving one end of said insert towards said membrane of said connector, and loading said membrane of said connector by means of said insert, so as to extend said membrane into said second channel so as to block a fluid flow through a second channel of said microfluidic device.
